(19) United States
(12) Patent Application Publication
(10) Pub. No.: US 2024/0382973 A1
(43) Pub. Date: Nov. 21, 2024

(54) WEAR PLATE

(71) Applicant: METSO FINLAND OY, Espoo (FI)

(72) Inventor: Elliott BRINDLE, Wells (GB)

(73) Assignee: METSO FINLAND OY, Espoo (FI)

(21) Appl. No.: 18/693,066

(22) PCT Filed: Sep. 23, 2022
(86) PCT No.: PCT/EP2022/076559

§ 371 Date: Mar. 18, 2024

(30) Foreign Application Priority Data
Sep. 24, 2021 (SE) 2151175-3

(51) Int. Cl. B02C 13/28

(52) U.S. Cl. CPC B02C 13/2804; B02C 2210/02

(57) ABSTRACT

A wear plate for a rotor for a comminution apparatus that is arrangeable adjacent to at least one of the wall elements and/or a further wear plate. The wear plate extends between an upper plate and a lower plate along a longitudinal direction. The wear plate includes a first body extending along a first general direction and has an upper surface, a lower surface, and a first abutment surface extending at least partially between the upper and lower surfaces. The wear plate includes a second body extending along a second general direction differing from the first general direction and has an upper surface, a lower surface, and a second abutment surface extending at least partially between the upper and lower surfaces. The wear plate is configured to abut a first surface and a second surface of the rotor such that, in use, forming a self-locking mechanism due to rotational force.

### FIELD OF THE DISCLOSURE

The present disclosure relates to crushing equipment for crushing rock, ore or similar. More specifically, the disclosure relates to a so-called vertical shaft impact crusher comprising one or more wear plates.

### BACKGROUND ART

When crushing rock, ore, cement clinker and other materials, vertical shaft impact crushers may be used having a rotor rotating around a vertical axis. The rotor may comprise a frame including an upper plate, a lower plate and wall elements extending between the upper plate and the lower plate. The material to be crushed is fed through a centrally arranged opening in an upper plate of the rotor. One or more outlets are located between the upper plate and the lower plate. A distributor plate is arranged at an upper surface of the lower plate of the rotor. As the material to be crushed hits the rotating distributor plate, the material will be hauled generally radially outwardly, through the one or more outlets, and hit an outer crushing surface, typically comprising a build-up of material to be crushed created on an inner surface of a crushing chamber creating an autogenous crushing. Such autogenous crushing has proven to guarantee superior shaped particles, for example aggregate. The rotor also comprises a plurality of wear parts protecting the rotor. Many of these are referred to as rotor tips or cavity wear plates. The rotor tips are often arranged at an exit of the respective outlet of the rotor. It is usually these parts which experience the greatest wear and tear. However, in current rotors, the wear parts are attached to the rotor by using fasteners, i.e. bolts or the like, which are often subject to excessive wear and tear. In addition, when replacing wear plates, there is usually a need of partially disassembling the rotor but sometimes also remove surrounding equipment in the crusher in order to be able to remove the wear parts.

In an attempt to meet this problem, WO 2013/140049 A1 suggests a rotor having a segmented wear plate with a channel running between an upper surface and a lower surface of the wear plate. Once the wear plate is arranged in position in the rotor, a mounting bar is arranged in the channel, extending between the upper plate and the lower plate of the rotor, thereby attaching the segmented wear plate to the rotor. A problem with the solution disclosed by WO 2013/140049 A1 is that there is a need of reaching the rotor from above in order to guide the mounting bar through the upper plate before entering the channel in the wear plate. There is thus a need in the art for a quicker and easier process when replacing a wear plate which is worn to the limit but also to provide a wear plate which is environmentally friendly.

### SUMMARY

It is an object to mitigate, alleviate or eliminate one or more of the above identified deficiencies in the art and disadvantages singly or in any combination and solve at least the above-mentioned problem.

According to a first aspect there is provided a wear plate for a rotor for a comminution apparatus. The rotor comprises a frame including an upper plate, a lower plate and wall elements extending between the upper plate and the lower plate along a longitudinal direction. The wear plate being arrangeable adjacent to at least one of the wall elements and/or a further wear plate and extends between the upper plate and the lower plate along the longitudinal direction. The wear plate comprising:
a first body which extends along a first general direction and has an upper surface, a lower surface, and a first abutment surface extending at least partially between the upper and lower surfaces of the first body, and
a second body which extends along a second general direction differing from the first general direction of the first body and has an upper surface, a lower surface, and a second abutment surface extending at least partially between the upper and lower surfaces of the second body,
wherein the first and second abutments surfaces of the wear plate is configured to abut corresponding first and second surfaces of the rotor such that, in use, a self-locking mechanism due to rotational force is formed.

The wear plate may be advantageous as it provides for a boltless installation of the wear plate in the rotor. The wear plate being designed to abut the first surface and the second surface of the rotor which facilitates provision of having a wear plate which is held in position in the rotor by forming a self-locking mechanism due to the rotational force, when the rotor is running. Thus, no additional fixing means are needed. It should be understood that the respective surface of the rotor may be a surface of the rotor frame itself, e.g. a surface of the upper plate, lower plate, or the wall elements. It should further be understood that the respective surface of the rotor may be a surface of a further wear plate arranged in the rotor. Thus, more than one wear plate may be comprised in the rotor or even more than one type of wear plates may be applied. The wear plate may be configured to abut a surface of the rotor itself and/or a surface of the further wear element arranged in the rotor. However, other components may be present in the rotor which the wear plate may abut and thereby being a part of forming the self-locking mechanism.

The disclosed design of the wear plate, in which the first body and the second body extends along different general directions, provides for a self-locking mechanism in respective direction which in turn helps keeping the wear plate in position in the respective direction. Put differently, the abutment surfaces of the wear plate are angled in relation to each other and thereby extends along different directions. The respective surfaces of the rotor are angled in relation to each other and thereby also extend along different directions. Preferably, the abutment surface of the wear plate extends along a direction substantially parallel to that of the corresponding surface of the rotor which the wear plate is supposed to abut. With this design of the wear plate in relation to the rotor surfaces, the self-locking mechanism may be formed due to the rotational forces and the boltless installation is achieved.

The term “extending at least partially between said upper plate and said lower plate” is here meant that at least a portion of the abutment surface of the wear plate abuts the corresponding surface of the rotor. Thus, the wear plate does not necessarily have to abut the corresponding surface of the rotor along the complete distance between the upper plate and lower plate of the rotor.

The wear plate is preferably arranged at an exposed area of the rotor. The term “exposed area” is here meant to concern any area in the rotor that is exposed to wear when the rotor is running. Thus, the wear plate is typically exposed to a great wear during its lifetime. Having a wear plate which may be installed in the rotor without the need of using any fixing means may be advantageous as it facilitates provision of a quick, easy, and user-friendly replacement of a wear plate worn to the limit. Moreover, having a boltless installation of the wear plate ensures that a limited amount of equipment is needed when replacing the worn out wear plate. This also facilitates replacing the worn out wear plate in a quick, easy, and user-friendly way. Also, due to the fact that the wear plate is easier to change when worn to the limit, means that less time has to be spent, which in turn reduces production downtime.

Hence, the wear plate is advantageous over the prior art in that it allows a boltless installation of the wear plate in the rotor. This in turn facilitates quick, easy, and user-friendly replacement of a wear plate worn to the limit leading to safer design in maintenance and installation point of view as well as reduced production downtime.

According to some embodiments, the wear plate further comprises a third body which extends along a third general direction differing from the first general direction of the first body and has an upper surface, a lower surface, and a third abutment surface extending at least partially between said upper and lower surfaces of the third body, wherein the wear plate is configured to abut a third surface of the rotor such that, in use, being part of the self-locking mechanism due to the rotational force.

This is advantageous as it allows the self-locking mechanism formed due to the rotational force to be further improved since the wear plate may abut also a third surface of the rotor in addition to the first and second surfaces. By having a wear plate which abuts more surfaces of the rotor, an improved stability of the wear plate is achieved, when the rotor is running.

According to some embodiments, at least one of the first, second and third surface of the rotor is arranged radially outside at least one of the first, second and third abutment surface of the wear plate.

This is advantageous in that by arranging the surface of the rotor radially outside at least one of the abutment surfaces provides for that the wear plate is kept in position in a radial direction when the rotor is in use. Put differently, in a preferred embodiment, there is always at least one surface of the rotor which is arranged radially outside a corresponding abutment surface of the wear plate in order for the self-locking mechanism due to the rotational force to be formed in the radial direction.

According to some embodiments, the upper surface and the lower surface of the respective body are flat surfaces.

This is advantageous in that is allows for a quick and easy installation and removal of the wear plate in the rotor, between the upper plate and lower plate. Put differently, having flat surfaces may provide for that the wear plate may be slidably arranged in the rotor, especially if an inner surface of the upper plate and lower plate are flat surfaces as well.

According to some embodiments, the wear plate further comprises a recess extending between the upper surface and the lower surface, the recess being configured to receive a tip of hard material, such as metal or ceramic material or similar, wherein the tip of hard material has greater hardness than the wear plate.

This is advantageous as it allows for inserting a tip of hard material having a greater hardness than the rest of the wear plate. Typically, the tip of hard material being positioned at a part of the wear plate which is exposed to the greatest wear and tear. In a preferred embodiment, the tip of hard material is made of metal. Moreover, the tip of hard material may be replaced when worn out although the rest of the wear plate is not. Thus, the recess and the tip of hard material may be advantageous in that the lifetime of the wear plate may be increased which may lead to a generally more environmentally friendly wear plate.

According to some embodiments, the first abutment surface abuts the first surface of the rotor which provides for keeping the wear plate in position in a radial direction and the second abutment surface abuts the second surface of the rotor which provides for keeping the wear plate in position a circumferential direction.

This is advantageous as it allows for the wear plate to be held in position in both the radial direction and the circumferential direction due to the rotational force occurring during use. The arrangement of the respective body of the wear plate in relation to the arrangement of the respective surface of the rotor provides for that the wear plate is held in position due to the rotational force.

According to some embodiments, the third abutment surface abuts the third surface of the rotor which provides for keeping the wear plate in position in the radial direction and/or the circumferential direction.

This is advantageous as it allows for an improved self-locking mechanism of the wear plate due to the rotational force. Thus, the more directions the wear plate is held in position during use, i.e. during rotation of the rotor, the better the retaining of the wear plate will be.

According to some embodiments, the wear plate is segmented in the longitudinal direction.

This is advantageous as it allows the wear plate to be formed by more than one element. By forming the wear plate by more than one element, each element may have a reduced weight compared to the weight of the complete wear plate. This may provide for that less heavy lifting which in turn provides for a safer design from a maintenance and installation point of view. Also, due to the fact that each wear plate element is smaller than the complete wear plate provides for that the wear plate elements may be installed or removed through a service door of the comminution apparatus. Thereby, there is no need to disassemble the crusher arrangement and/or the rotor to be able to replace the wear plate.

This is further advantageous as it allows the different wear plate elements forming the segmented wear plate to be installed in relation to each other in a boltless way. Thus, the respective wear plate element forms the self-locking mechanism in relation to the respective surface of the rotor due to the rotational force.

Typically, the wear plate is worn unevenly along its profile. Having a segmented wear plate provides for that only the element of the wear plate which is worn out may be replaced instead of replacing the complete wear plate. By being able to only replace a worn out element instead of the complete wear plate provides for that a more environmentally friendly wear plate is achieved. Further, the fact that the wear plate is worn unevenly along its profile, the use of a segmented wear plate allows that the wear plate elements can change position with each other instead of being replaced. This increases the total lifetime of the wear plate.

According to some embodiments, the wear plate comprises at least a first element, a second element and a third element being arranged one after another in said order along the longitudinal direction.

According to some embodiments, the first element and the third element may swap positions.

This is advantageous as it allows each wear plate element to be worn to the limit along its complete profile. Typically, the first element and the third element being worn opposite which provides for that they may swap positions in order to be evenly worn out along its complete profile. Moreover, when the upper and lower surfaces being flat surfaces, this also provides for that the swapping may be executed in an easy way.

According to some embodiments, the wear plate comprises at least a first element, a second element, a third element and a fourth element being arranged one after another in said order along the longitudinal direction. According to some embodiments, the first element and the third element may swap positions, and the second element and the fourth element may swap positions.

According to some embodiments, the wear plate is a rotor tip.

According to some embodiments, the wear plate is a tip carrier wear plate.

According to some embodiments, the wear plate is a cavity wear plate.

According to a second aspect, there is provided a rotor for a comminution apparatus comprising:
a frame including an upper plate, a lower plate and wall elements extending between the upper plate and the lower plate along a longitudinal direction, and
a wear plate being arrangeable adjacent to at least one of the wall elements and/or a further wear plate and extends between the upper plate and the lower plate along the longitudinal direction, the wear plate comprising:
a first body which extends along a first general direction and has an upper surface, a lower surface, and a first abutment surface extending at least partially between the upper and lower surfaces of the first body, and
a second body which extends along a second general direction differing from the first general direction of the first body and has an upper surface, a lower surface, and a second abutment surface extending at least partially between the upper and lower surfaces of the second body,
wherein the wear plate is configured to abut a first surface and a second surface of the rotor such that, in use, forming a self-locking mechanism due to rotational force.

According to some embodiments, the wear plate further comprises a third body which extends along a third general direction differing from the first general direction of the first body and has an upper surface, a lower surface, and a third abutment surface extending at least partially between the upper and lower surfaces of the third body, wherein the wear plate is configured to abut a third surface of the rotor such that, in use, being part of forming the self-locking mechanism due to the rotational force.

According to a third aspect, there is provided a comminution apparatus for crushing or grinding hard materials, said comminution apparatus comprising:
a rotor having a frame including an upper plate, a lower plate and wall elements extending between said upper plate and said lower plate along a longitudinal direction, and
a wear plate which is arrangeable adjacent to at least one of said wall elements and/or a further wear plate and extends between said upper plate and said lower plate along the longitudinal direction, said wear plate comprising:
a first body which extends along a first general direction and has an upper surface, a lower surface, and a first abutment surface extending at least partially between said upper and lower surfaces of the first body, and
a second body which extends along a second general direction differing from the first general direction of the first body and has an upper surface, a lower surface, and a second abutment surface extending at least partially between said upper and lower surfaces of the second body,
wherein the first abutment surface and the second abutment surface of the wear plate are configured to abut a first surface and a second surface of the rotor such that, in use, forming a self-locking mechanism due to rotational force.

Effects and features of the second and third aspects are largely analogous to those described above in connection with the first aspect. Embodiments mentioned in relation to the first aspect are largely compatible with the second aspect and third aspects. It is further noted that the inventive concepts relate to all possible combinations of features unless explicitly stated otherwise.

A further scope of applicability of the present disclosure will become apparent from the detailed description given below. However, it should be understood that the detailed description and specific examples, while indicating preferred embodiments of the disclosure, are given by way of illustration only, since various changes and modifications within the scope of the disclosure will become apparent to those skilled in the art from this detailed description.

Hence, it is to be understood that this disclosure is not limited to the particular component parts of the device described or steps of the methods described as such device and method may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The disclosure will by way of example be described in more detail with reference to the appended drawings, which shows presently preferred embodiments of the disclosure.

FIG. 1 shows a perspective view of a comminution apparatus.

FIG. 2 shows a side view of the rotor.

FIG. 3 shows an interior of the rotor of FIG. 2.

FIG. 4 shows a top view of the rotor of FIGS. 2 and 3.

FIG. 5a-b shows a first embodiment of the wear plate.

FIG. 6a-c shows a second embodiment of the wear plate.

FIG. 7a-b shows a third embodiment of the wear plate.

### DETAILED DESCRIPTION

The present disclosure will now be described more fully hereinafter with reference to the accompanying drawings, in which currently preferred embodiments of the disclosure are shown. This disclosure may, however, be embodied in many different forms and should not be construed as limited to the embodiments set forth herein; rather, these embodiments are provided for thoroughness and completeness, and fully convey the scope of the disclosure to the skilled person.

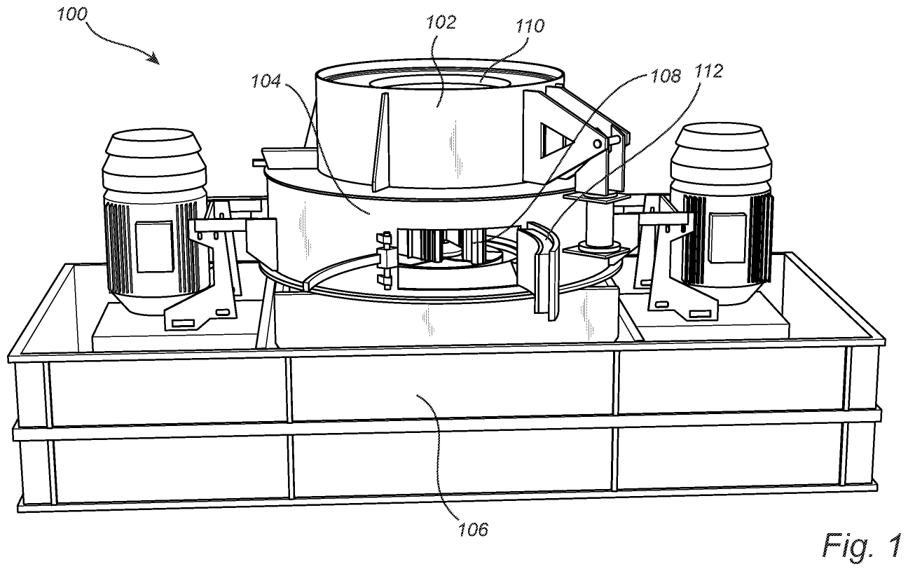

FIG. 1 illustrates a comminution apparatus 100 for crushing or grinding rock, ore, cement clinker and other hard materials by way of example. The comminution apparatus 100 is configured to crush the materials by impact. The comminution apparatus 100 may be a vertical shaft impact crusher.

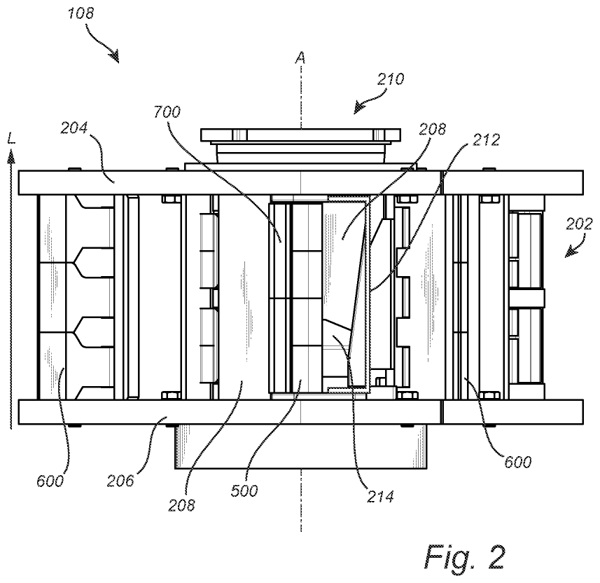

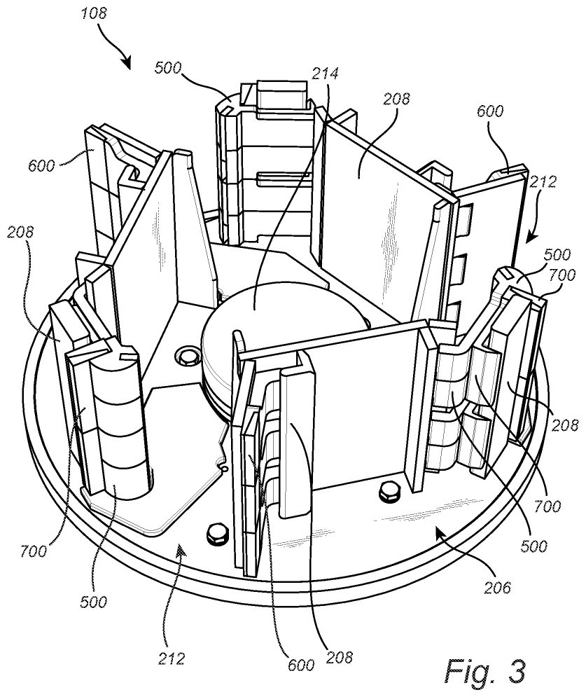

The comminution apparatus 100 comprises a roof 102 and a chamber 104. The chamber 104 is arranged on a base 106 of the comminution arrangement 100. The roof 102 is arranged on top of the chamber 104. The comminution apparatus 100 further comprises a feed opening 110. The feed opening 110 is arranged inside the roof 102. The feed opening 110 may be configured to receive materials to be crushed and to feed the material to the chamber 104. The comminution arrangement 100 further comprises a rotor 108. The rotor 108 is arranged inside the chamber 104. The rotor 108 is configured to accelerate the material received in the chamber 104 towards a crushing surface. Thus, the rotor is the main working component of the comminution apparatus 100. The rotor 108 will be further discussed in connection with FIGS. 2-3.

Moreover, the comminution apparatus 100 may also comprise a service door 112.

With reference to FIG. 2, the rotor 108 is illustrated in further detail. The rotor comprises a frame 202. The frame 202 includes an upper plate 204, a lower plate 206 and wall elements 208. The wall elements 208 extend between the upper plate 204 and the lower plate 206 along a longitudinal direction L. The rotor 108 further comprises an inlet opening 210 and an outlet 212. The inlet opening 210 is arranged in the upper plate 204. The outlet 212 is located between the upper plate 204 and the lower plate 206. The rotor 108 may comprise more than one outlet 212. During operation of the comminution apparatus 100, the rotor 108 is configured to rotate about a rotational axis A. The rotational axis A is a vertical axis being generally parallel to the longitudinal direction L. The rotor 108 preferably rotates counterclockwise about the rotational axis A. The rotor 108 further comprises a distributor plate 214. As the material to be crushed hits the rotating distributor plate 214, the material will be hauled generally radially outwardly, through the outlets 212, and hit an interior surface of the chamber in which the rotor 108 is positioned.

The rotor 108 further comprises wear plates 500, 600, 700. The wear plates 500, 600, 700 may extend between the upper plate 204 and the lower plate 206 of the rotor 108 along the longitudinal direction L. The wear plates 500, 600, 700 are preferably arranged at exposed areas of the rotor. Put differently, the wear plate 500, 600, 700 may be arranged in any area of the rotor 108 that is exposed to wear when the rotor 108 is running. The wear plates will be further discussed in connection with FIGS. 3-7.

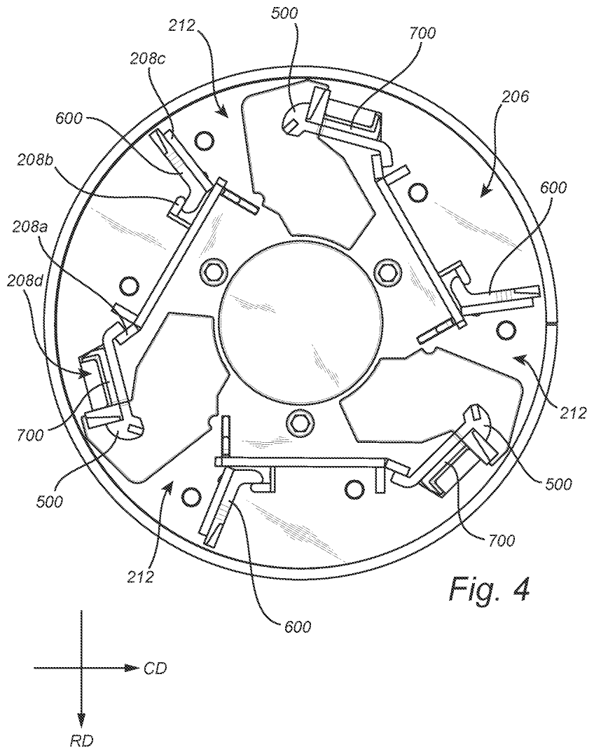

With reference to FIGS. 3 and 4, an interior of the rotor 108 is illustrated by way of example. Further to what have been discussed above, the wear plates 500, 600, 700 may be arranged adjacent to at least one of the wall elements 208 of the rotor 108. The wear plates 500, 600, 700 may also be arranged adjacent a further wear element 500, 600, 700 arranged in the rotor 108.

When the rotor 108 is running, a wear plate 500, 600, 700 may abut a first surface and a second surface of the rotor 108 such that a self-locking mechanism may be formed due to rotational force. The surfaces of the rotor 108 which the wear plate 500, 600, 700 may abut is typically one or more of the at least one wall element 208 and/or a further wear plate 500, 600, 700 which the wear plate 500, 600, 700 is arranged adjacent to when installed in the rotor 108. The wear plate 500, 600, 700 may further abut a third surface of the rotor 108 such that the self-locking mechanism due to the rotational force is further improved.

In a preferred embodiment, at least one of the first, second and third surfaces of the rotor 108 is arranged radially outside at least a part of the wear plate 500, 600, 700 such that the wear plate 500, 600, 700 may be held in position in a radial direction RD due to the rotational force.

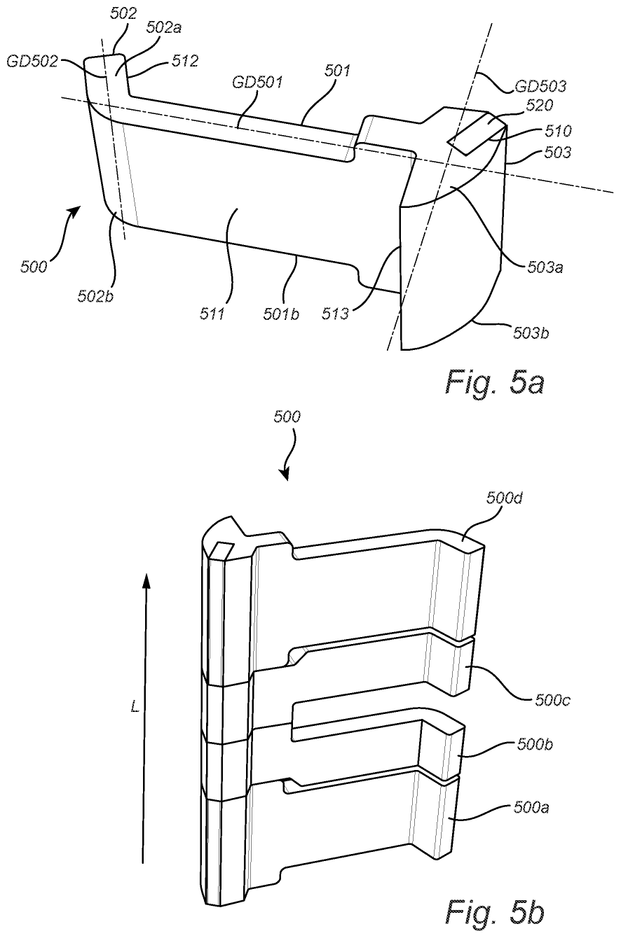

With reference to FIGS. 5-7, different embodiments of the wear plate 500, 600, 700 are illustrated by way of example. The wear plate 500, 600, 700 comprises a first body 501, 601, 701. The first body 501, 601, 701 extends along a first general direction GD501, GD601, GD701. The first body 501, 601, 701 has an upper surface 501a, 601a, 701a and a lower surface 501b, 601b, 701b. The first body 501, 601, 701 has a first abutment surface 511, 611, 711. The first abutment surface 511, 611, 711 extends at least partially between the upper surface 501a, 601a, 701a and the lower surface 501b, 601b, 701b of the first body 501, 601, 701 and may in some embodiments extend all the way between the upper surface 501a, 601a, 701a and the lower surface 501b, 601b, 701b of the first body 501, 601, 701. The wear element 500, 600, 700 further comprises a second body 502, 602, 702. The second body 502, 602, 702 extends along a second general direction GD502, GD602, GD702. The second body 502, 602, 702 has an upper surface 502a, 602a, 702a and a lower surface 502b, 602b, 702b. The second body 502, 602, 702 has a second abutment surface 512, 612, 712. The second abutment surface 512, 612, 712 extends at least partially between the upper surface 502a, 602a, 702a and the lower surface 502b, 602b, 702b of the second body 502, 602, 702 and may in some embodiments extend all the way between the upper surface 502a, 602a, 702a and the lower surface 502b, 602b, 702b of the second body 502, 602, 702.

The wear element 500, 600, 700 may further comprise a third body 503, 603, 703. The third body 503, 603, 703 extends along a third general direction GD503, GD603, GD703. The third body 503, 603, 703 has an upper surface 503a, 603a, 703a and a lower surface 503b, 603b, 703b. The third body 503, 603, 703 has a third abutment surface 513, 613, 713. The third abutment surface 513, 613, 713 extends at least partially between the upper surface 503a, 603a, 703a and the lower surface 503b, 603b, 703b of the third body 503, 603, 703 and may in some embodiments extend all the way between the upper surface 503a, 603a, 703a and the lower surface 503b, 603b, 703b of the second body 503, 603, 703.

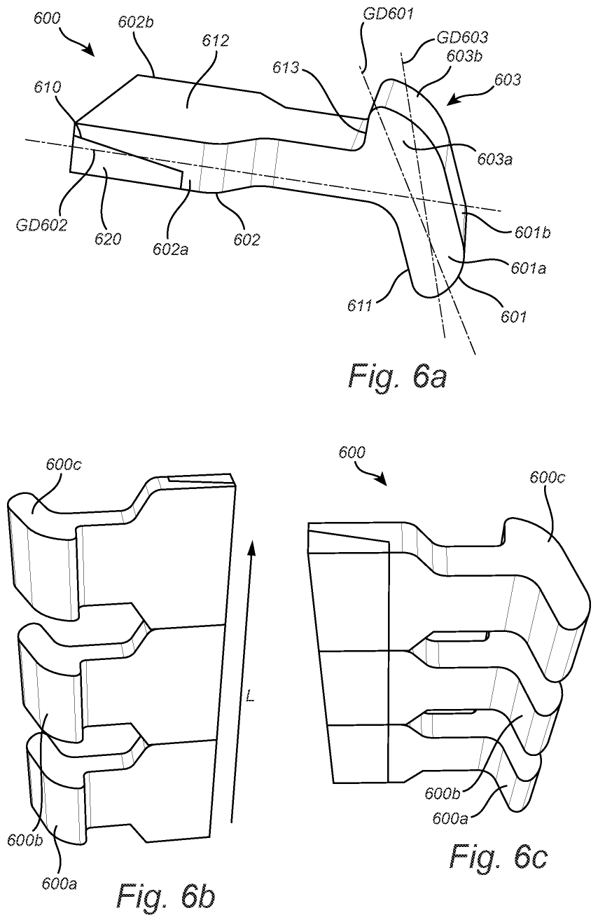

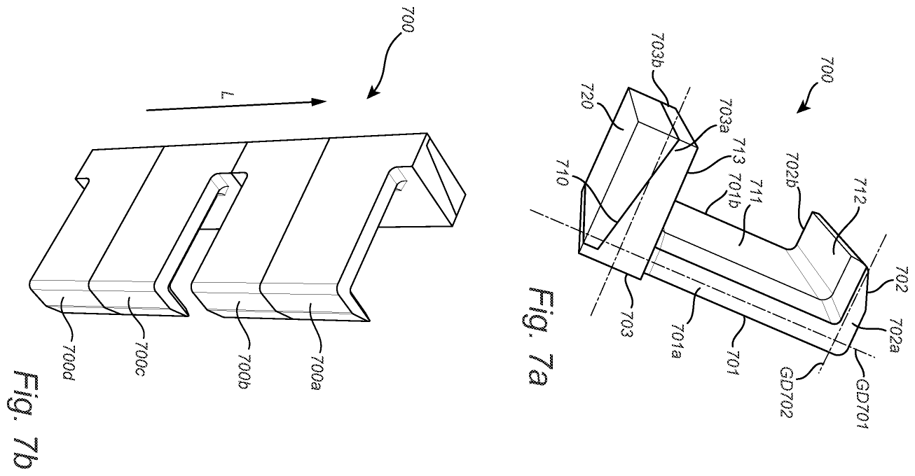

Hereinafter, the first embodiment 500 of the wear plate will be referred to as a first wear plate 500. The second embodiment 600 of the wear plate will be referred to as a second wear plate 600. The third embodiment 700 of the wear plate will be referred to as a third wear plate 700. With reference to FIG. 5a-b, the first wear plate 500 is illustrated in further detail. With reference to FIG. 6a-c, the second wear plate 600 is illustrated in further detail. With reference to FIG. 7a-b, the third wear plate is illustrated in further detail.

As best illustrated in FIG. 4, the first wear plate 500 is positioned at an exit side of the outlets 212, facing the outlets 212. As the material being hauled outwardly through the outlets 212, some material may hit the first wear plate 500 which may experience great wear and tear when the comminution apparatus 100 is running. The first wear plate 500 may be a rotor tip. Typically, these wear plates experience the greatest wear and tear of the wear plates arranged in the rotor 108.

The first wear plate 500 is arranged adjacent to the third wear plate 700. The third wear plate 700 comprising a first surface of the rotor 108, and the wall element 208a comprising a second surface of the rotor 108. When the rotor 108 is running, the first wear plate 500 abuts the third wear plate 700 and the wall element 208a such that the self-locking mechanism is formed during rotation due to the rotational force. The first abutment surface 511 of the first wear plate 500 abuts a surface of the third wear plate 700. This keeps the first wear plate 500 in position in a radial direction RD. The second abutment surface 512 of the first wear plate 500 abuts the wall element 208a. This keeps the first wear plate 500 in position in a circumferential direction CD.

The first wear plate 500 is further arranged adjacent to an outer surface of the third wear plate 700, comprising a third surface of the rotor 108. When the rotor 108 is running, the first wear plate 500 may abut the third wear plate 700 such that the self-locking mechanism is further formed due to the rotational force. The third abutment surface 513 of the wear plate 500 abuts the outer surface of the third wear plate 700. This may provide for keeping the first wear plate 500 in position in the direction CD. The provision of the second abutment surface 512 and the third abutment surface 513 of the wear plate 500 ensures that the wear plate 500 is prevented from being dislodged in a circumferential direction of the rotor 108.

The second wear plate 600 is positioned just upstream of the outlets 212, when rotating the rotor in a counter-clockwise direction, wherein a wall element 208c is positioned between the second wear plate 600 and the outlet 212. The second wear plate 600 is positioned adjacent one side of the wall element 208c, being the side opposite the side of the wall element 208c which is facing the outlet 212. As the material being hauled outwardly through the outlets 212, some material may hit the second wear plate 600. The second wear plate 600 is sometimes called a cavity wear plate.

The second wear plate 600 is arranged adjacent to two wall elements 208b, 208c, comprising a first and a second surface of the rotor 108. When the rotor 108 is running, the second wear plate 600 may abut the respective wall element 208b, 208c such that the self-locking mechanism is formed due to the rotational force. The first abutment surface 611 of the second wear plate 600 abuts the wall element 208b. This may provide for keeping the second wear plate 600 in position in the radial direction RD. The second abutment surface 612 of the second wear plate 600 abuts a surface wall elements 208c. This may provide for keeping the wear plate 600 in position in the circumferential direction CD.

The second wear plate 600 may be arranged adjacent to a further wall element 208, being a third surface of the rotor 108. When the rotor 108 is running, the second wear plate 600 may abut the further wall element 208 such that the self-locking mechanism is further formed due to the rotational force. The third abutment surface 613 is located at the heel-shaped third body 603 of the second wear plate 600. This heel-shaped third body 603 extends through a corresponding opening in wall element 208c and abuts an internal surface in the opening in wall element 208c. This keeps the second wear plate 600 in position in the direction CD. Thus, similar to the first wear plate 500, the second wear plate 600 is kept in place by applying three abutment surfaces extending in different directions, thereby creating a reliable self-locking mechanism during rotation of the rotor 108.

The third wear plate 700 is positioned radially outside the first wear plate 500. As the material being hauled outwardly through the outlets 212, some material may hit the third wear plate 700. The third wear plate 700 is sometimes called tip carrier wear plate.

The third wear plate 700 is arranged adjacent to a wall element 208d, comprising first, second and third surfaces of the rotor 108. Herein, the first surface of the wall element 208d is facing radially inwardly of the rotor 108 and the second and third surfaces are the side surfaces of the wall element 208d being generally perpendicular to the first surface. When the rotor 108 is running, the third wear plate 700 abuts first, second and third surfaces of the wall element 208d such that the self-locking mechanism is formed due to the rotational force. The first abutment surface 711 of the third wear plate 700 abuts the first side of the wall element 208d which faces radially inwardly. This keeps the third wear plate 700 in position in the radial direction RD. The second and third abutment surfaces 712, 713 of the third wear plate 700 abut the side surfaces of the wall element 208d. This keeps the third wear plate 700 in position in the circumferential direction CD.

The third wear plate 700 is further arranged adjacent to the first wear plate 500. When the rotor 108 is running, the third wear plate 700 may abut the first wear plate 500 such that the self-locking mechanism is further formed due to the rotational force. Thus, the interaction between the first wear plate 500, third wear plate 700 and the wall element 208d keeps the wear plates 500, 700 in position in the circumferential direction CD and in the radial direction RD.

Referring back to FIGS. 5-7 the upper surface and the lower surface of the respective body of the wear plate 500, 600, 700 are flat surfaces.

The wear plate 500, 600, 700 may further comprise a recess 510, 610, 710. The recess 510, 610, 710 may extend between the upper surface and the lower surface of the wear plate 500, 600, 700. The recess 510, 610, 710 is configured to receive a tip of hard metal 520, 620, 720. Preferably, the tip of metal 520, 620, 720 has a greater hardness than the wear plate 500, 600, 700.

Moreover, the wear plate 500, 600, 700 may be a segmented wear plate. The wear plate may comprise a first element 500a, 600a, 700a, a second element 500b, 600b, 700b and a third element 500c, 600c, 700c. The elements may be arranged one after another in said order along the longitudinal direction L. The wear element 500, 700 may comprise a fourth element 500d, 700d being arranged after the third element 500c, 700c along the longitudinal direction L. Preferably, the first element 500a, 600a, 700a and the third element 500c, 600c, 700c may have a similar or identical design. This provides that the first element 500a, 600a, 700a and the third element 500c, 600c, 700c may swap positions.

Preferably, the second element 500b, 700b and the fourth element 500d, 700d may have a similar design. This provides that the second element 500b, 700b and the fourth element 500d, 700d may swap positions.

Thus, it is understood that the purpose of the disclosure is to reduce the problems with replacing worn out wear plates in the rotor 108 by providing a boltless installation of the wear part. This is achieved due to the design of the wear plate in relation to specific surfaces of the rotor 108 which the wear plate will abut when installed in the rotor 108. This provides for that the self-locking mechanism is formed due to the rotational force. A further purpose is to provide for a more environmentally friendly wear plate. Also, due to the fact that the wear plate 500, 600, 700 may be a segmented wear plate, it is also understood that the purpose of the disclosure is to provide for that the segmented wear plate may be installed or removed through the service door 112 of the comminution apparatus 100. Thereby, there is no need to disassemble the comminution apparatus 100 and/or the rotor 108 to be able to replace the wear plate 500, 600, 700.

The person skilled in the art realizes that the present invention by no means is limited to the preferred embodiments described above. On the contrary, many modifications and variations are possible within the scope of the appended claims. Additionally, variations to the disclosed embodiments can be understood and effected by the skilled person in practicing the claimed invention, from a study of the drawings, the disclosure, and the appended claims.

1-16. (canceled)

17. A wear plate for a rotor for a comminution apparatus, said rotor comprising a frame including an upper plate, a lower plate and wall elements extending between said upper plate and said lower plate along a longitudinal direction, said wear plate being arrangeable adjacent to at least one of said wall elements and/or a further wear plate and extends between said upper plate and said lower plate along the longitudinal direction, said wear plate comprising:
a first body which extends along a first general direction and has an upper surface, a lower surface, and a first abutment surface extending at least partially between said upper and lower surfaces of the first body;
a second body which extends along a second general direction differing from the first general direction of the first body and has an upper surface, a lower surface, and a second abutment surface extending at least partially between said upper and lower surfaces of the second body; and
a third body which extends along a third general direction differing from the first general direction of the first body and has an upper surface, a lower surface, and a third abutment surface extending at least partially between said upper and lower surfaces of the third body,
wherein the first abutment surface, the second abutment surface and the third abutment surface of the wear plate are configured to abut a first surface of the rotor or of the further wear plate, a second surface of the rotor or of the further wear plate and a third surface of the rotor or of the further wear plate, respectively, such that, in use, forming a self-locking mechanism due to rotational force without additional fixing means.

18. The wear plate according to claim 17, wherein at least one of the first, second and third abutment surface of the wear plate is configured to be arranged radially inside at least one of the first, second and third surface of the rotor or of the further wear plate.

19. The wear plate according to claim 17, wherein the upper surface and the lower surface of the respective body are flat surfaces.

20. The wear plate according to claim 17, wherein the wear plate further comprises a recess extending between the upper surface and the lower surface, the recess being configured to receive a tip of metal, wherein the tip of metal has greater hardness than the wear plate.

21. The wear plate according to claim 17, wherein the first abutment surface is configured to abut the first surface of the rotor or of the further wear plate which provides for keeping the wear plate in position in a radial direction and the second abutment surface is configured to abut the second surface of the rotor or of the further wear plate which provides for keeping the wear plate in position in a circumferential direction.

22. The wear plate according to claim 17, wherein the third abutment surface is configured to abut the third surface of the rotor or of the further wear plate which provides for keeping the wear plate in position in the radial direction and/or the circumferential direction.

23. The wear plate according to claim 17, wherein the wear plate is segmented.

24. The wear plate according to claim 23, wherein the wear plate comprises at least a first element, a second element and a third element being arranged one after another in said order along the longitudinal direction.

25. The wear plate according to claim 24, wherein the first element and the third element may swap positions.

26. The wear plate according to claim 17, wherein the wear plate is a rotor tip.

27. The wear plate according to claim 17, wherein the wear plate is a tip carrier wear plate.

28. The wear plate according to claim 17, wherein the wear plate is a cavity wear plate.

29. A rotor for a comminution apparatus comprising:
a frame including an upper plate, a lower plate and wall elements extending between said upper plate and said lower plate along a longitudinal direction, said wear plate being arrangeable adjacent to at least one of said wall elements and/or a further wear plate and extends between said upper plate and said lower plate along the longitudinal direction, said wear plate comprising:
a first body which extends along a first general direction and has an upper surface, a lower surface, and a first abutment surface extending at least partially between said upper and lower surfaces of the first body;
a second body which extends along a second general direction differing from the first general direction of the first body and has an upper surface, a lower surface, and a second abutment surface extending at least partially between said upper and lower surfaces of the second body;
a third body which extends along a third general direction differing from the first general direction of the first body and has an upper surface, a lower surface, and a third abutment surface extending at least partially between said upper and lower surfaces of the third body;
wherein the first abutment surface, the second abutment surface and the third surface of the wear plate are configured to abut a first surface of the rotor or of the further wear plate, a second surface of the rotor or of the further wear plate and a third surface of the rotor or of the further wear plate, respectively, such that, in use, forming a self-locking mechanism due to rotational force without additional fixing means.

30. The rotor according to claim 29, wherein the first abutment surface is configured to abut the first surface of the rotor or of the further wear plate which provides for keeping the wear plate in position in a radial direction and the second abutment surface is configured to abut the second surface of the rotor or of the further wear plate which provides for keeping the wear plate in position in a circumferential direction.

31. The rotor according to claim 29, wherein the third abutment surface is configured to abut the third surface of the rotor or of the further wear plate which provides for keeping the wear plate in position in the radial direction and/or the circumferential direction.

32. A comminution apparatus for crushing or grinding hard materials, said comminution apparatus comprising:
a rotor having a frame including an upper plate, a lower plate and wall elements extending between said upper plate and said lower plate along a longitudinal direction; and
a wear plate which is arrangeable adjacent to at least one of said wall elements and/or a further wear plate and extends between said upper plate and said lower plate along the longitudinal direction, said wear plate comprising:
a first body which extends along a first general direction and has an upper surface, a lower surface, and a first abutment surface extending at least partially between said upper and lower surfaces of the first body;
a second body which extends along a second general direction differing from the first general direction of the first body and has an upper surface, a lower surface, and a second abutment surface extending at least partially between said upper and lower surfaces of the second body; and
a third body which extends along a third general direction differing from the first general direction of the first body and has an upper surface, a lower surface, and a third abutment surface extending at least partially between said upper and lower surfaces of the third body,
wherein the first abutment surface, the second abutment surface and the third abutment surface of the wear plate are configured to abut a first surface of the rotor or of the further wear plate, a second surface of the rotor or of the further wear plate and a third surface of the rotor or of the further wear plate, respectively, such that, in use, forming a self-locking mechanism due to rotational force without additional fixing means.

33. The comminution apparatus according to claim 32, wherein the first abutment surface is configured to abut the first surface of the rotor or of the further wear plate which provides for keeping the wear plate in position in a radial direction and the second abutment surface is configured to abut the second surface of the rotor or of the further wear plate which provides for keeping the wear plate in position in a circumferential direction.

34. The comminution apparatus according to claim 32, wherein the third abutment surface is configured to abut the third surface of the rotor or of the further wear plate which provides for keeping the wear plate in position in the radial direction and/or the circumferential direction.
